(19) United States
(12) Patent Application Publication
(10) Pub. No.: US 2014/0356486 A1
(43) Pub. Date: Dec. 4, 2014

(54) SUSHI RICE CAPABLE OF BEING FROZEN AND THEN CONVENTIONALLY THAWED

(71) Applicant: RiceWrap Foods Corporation, Raleigh, NC (US)

(72) Inventors: Richard Hamilton Cronk, Raleigh, NC (US); Kyle Hamilton Cronk, Raleigh, NC (US)

(73) Assignee: RICEWRAP FOODS CORPORATION, Raleigh, NC (US)

(21) Appl. No.: 14/369,019

(22) PCT Filed: Dec. 27, 2012
(86) PCT No.: PCT/US2012/071787

§ 371 Date: Jun. 26, 2014

Related U.S. Application Data
(60) Provisional application No. 61/580,460, filed on Dec. 27, 2011.

(51) Int. Cl. A23L 1/18; A23L 3/36; A23L 1/00

(52) U.S. Cl. CPC A23L 1/1817; A23L 1/005; A23L 3/36; A23V 2002/00
USPC 426/96; 426/292

(57) ABSTRACT

The present invention relates to a method for making rice capable of being frozen and then defrosted by conventional means rather than microwaved to defrost. The product includes cooked sushi rice kernels that have been coated with trehalose such that the total sugars consist of between 9% and about 60% trehalose.

The application claims priority of U.S. non-provisional application No. 61/580,460 filed on Dec. 27, 2011 and is included herein in its entirety by reference

### COPYRIGHT NOTICE

A portion of the disclosure of this patent contains material that is subject to copyright protection. The copyright owner has no objection to the reproduction by anyone of the patent document or the patent disclosure as it appears in the Patent and Trademark Office patent files or records, but otherwise reserves all copyright rights whatsoever.

### BACKGROUND OF THE INVENTION

1. Field of the Invention

The present invention relates to sushi rice. In particular, the present invention relates to sushi rice capable of being thawed at room temperature after being frozen and to methods of making such sushi rice.

2. Description of Related Art

After cooked rice comes to room temperature, it begins to deteriorate in flavor and after a period of time becomes inedible and its ability to be preserved deteriorates. Sushi rice overcomes some of these problems by adding vinegar or sweetened vinegar to the rice. Still, even sushi rice needs to be eaten in a short period of time before it irreversibly becomes inedible. In order overcome the problems of having quickly deteriorating sushi rice, the rice can be frozen for later use. However, frozen sushi rice needs to be quickly heated to be useful and the usual method is to heat the frozen sushi rice in a microwave. Such rice is even more unpalatable if allowed to defrost normally, becoming hard and useless.

Rice that has been frozen deteriorates in taste quickly and therefore must be quickly defrosted if it is to be used. Normally, a microwave is utilized for such purposes. Microwaved rice has a pleasant taste and texture while it remains warm but quickly deteriorates as well. In addition, in places where a microwave is impractical it is impossible to use such frozen sushi rice. If frozen sushi rice is defrosted using the generally accepted conventional thawing method for foods, i.e. defrosting at room temperature or in the refrigerator (the preferred method for defrosting most foods), the rice is spoiled in taste by the time it is defrosted and is to be used.

Attempts have been made to produce a sushi rice that, when frozen, can be thawed at room temperature without deterioration of the taste. In one method gelatin and oligosaccharide are added to the rice during the production of sushi rice. In another method a combination of trehalose and reduced starch syrup is added to the water while the rice is cooking and then sucrose (frequently in the sushi vinegar) is added to the cooked rice wherein the content of the sugars is at least 7% sugar but no more than 12%. No coating of the rice occurs nor is such coating taught. It is taught however, that it does not work below 7% or is too sweet above 12%. Various places for adding trehalose and/or starch syrup are taught but only the addition to the cooking water has actually previously been attempted. Conclusions about the method were drawn from this one method of making. These methods still produce a product that is only marginally better than untreated sushi rice and in the case of the latter method, does not produce a rice that has acceptable texture if thawed in the refrigerator and too much sucrose produces an overly sweet sushi rice, thus affecting the expected taste of the final product.

The need still exists to be able to produce sushi rice that can be frozen and then defrosted by conventional methods and not microwaved, yet produce a product that when thawed is not overly sweet and has the texture that is closer to fresh made sushi rice.

### BRIEF SUMMARY OF THE INVENTION

The present invention relates to the discovery that if the trehalose is added to one or more of sucrose, high fructose corn syrup, and brown sugar and adding trehalose such that the total sugar content is in an embodiment made up of at least 40% trehalose by weight of all sugars, and the trehalose is at least about 9% by weight of the uncooked sushi rice kernels and sugars together; during the addition of sushi vinegar during the cooling phase of making sushi rice, the resulting rice can be frozen and conventionally defrosted without affecting the taste and texture of the sushi rice.

In one embodiment, the present invention relates to a sushi rice which is capable of being frozen and then conventionally thawed comprising uncooked sushi rice kernels which have been cooked to produce cooked rice kernels to which has been added:
a) sushi vinegar;
b) a combination of sugars consisting of one or more of sucrose, high fructose corn syrup, and brown sugar of from 0% to about 13% by weight of the uncooked sushi rice kernels;
c) trehalose of from not less than 9% and not more than about 60% by weight, of the combination of sugars and uncooked sushi rice kernels combined; and
d) wherein the combination of sugars and trehalose has been mixed with the cooked rice kernels such that they coat at least a portion of an outer surface of the cooked rice kernels.

In another embodiment, the present invention relates to a method of making sushi rice which is capable of being frozen and then conventionally thawed comprising;
a) selecting a desired amount of uncooked rice kernels;
b) cooking the uncooked rice kernels in sufficient heated water to form cooked rice kernels;
c) adding to the cooked rice kernels a combination of sugars comprising of at least one of sucrose, high fructose corn syrup, and brown sugar such that sugars are from about 0% to about 13% by weight of the uncooked rice;
d) adding to the cooked rice kernels trehalose together with the combination of sugars or separately of not less than 9% nor more than about 60%, by weight, of the uncooked sushi rice kernels and combination of sugars combined; and
e) making the addition of c) and d) in a manner wherein at least a portion of the cooked rice kernels are coated with the combination of sugars and trehalose.

### DETAILED DESCRIPTION OF THE INVENTION

While this invention is susceptible to embodiment in many different forms, there is shown in the drawings and will herein be described in detail specific embodiments, with the understanding that the present disclosure of such embodiments is to be considered as an example of the principles and not intended to limit the invention to the specific embodiments shown and described. In the description below, like reference numerals are used to describe the same, similar or corresponding parts in the several views of the drawings. This detailed description defines the meaning of the terms used herein and specifically describes embodiments in order for those skilled in the art to practice the invention.

The terms “a” or “an”, as used herein, are defined as one or as more than one. The term “plurality”, as used herein, is defined as two or as more than two. The term “another”, as used herein, is defined as at least a second or more. The terms “including” and/or “having”, as used herein, are defined as comprising (i.e., open language). The term “coupled”, as used herein, is defined as connected, although not necessarily directly, and not necessarily mechanically.

Reference throughout this document to “one embodiment”, “certain embodiments”, and “an embodiment” or similar terms means that a particular feature, structure, or characteristic described in connection with the embodiment is included in at least one embodiment of the present invention. Thus, the appearances of such phrases or in various places throughout this specification are not necessarily all referring to the same embodiment. Furthermore, the particular features, structures, or characteristics may be combined in any suitable manner in one or more embodiments without limitation.

The term “or” as used herein is to be interpreted as an inclusive or meaning any one or any combination. Therefore, “A, B or C” means any of the following: “A; B; C; A and B; A and C; B and C; A, B and C”. An exception to this definition will occur only when a combination of elements, functions, steps or acts are in some way inherently mutually exclusive.

As used herein the term “about” and “essentially” refers to ±5%.

As used herein the term “substantially” refers to ±5%.

The term “comprising” is not intended to limit inventions to only claiming the present invention with such comprising language. Any invention using the term comprising could be separated into one or more claims using “consisting” or “consisting of” claim language and is so intended.

The drawings featured in the figures are for the purpose of illustrating certain convenient embodiments of the present invention, and are not to be considered as limitation thereto. Term “means” preceding a present participle of an operation indicates a desired function for which there is one or more embodiments, i.e., one or more methods, devices, or apparatuses for achieving the desired function and that one skilled in the art could select from these or their equivalent in view of the disclosure herein and use of the term “means” is not intended to be limiting.

As used herein the term “sushi rice” refers to rice that is cooked and then vinegar and sugars mixed together with the rice to make sushi type dishes. Optional ingredients like salt or other spices and flavorings are normally added as desired. Rice that is utilized for sushi can be almost any kind of rice, short, medium or long grain rice, but in general, short and medium rice are normally utilized in the preparation of sushi. In one embodiment of the invention, a mixture of rice can be utilized. Once the vinegar is added to the cooked rice, the mixture is usually tumbled or otherwise mixed to flavor all the cooked kernels of cooked rice. Sushi rice is utilized in all types of sushi including nigiri, nari, maki, and ashi. Other types can also be utilized as desired.

As used herein the term “uncooked rice kernels” refers to the selection of uncooked short, medium, or long grain sushi rice grains or kernels. One would generally pick the uncooked rice normally used or preferred for making sushi rice not of the present invention; however, the present invention is useful with all sushi type rice kernels. In one embodiment, the selection of uncooked rice kernels is a combination of both short and medium grain rice kernels. In one embodiment, the ratio of short to medium grain rice kernels is from a ratio of about 1:3 to about 3:1 by either weight or volume measurement.

The “desired amount” of uncooked rice kernels to use in the process of the present invention can be any amount that can be handled in the general sushi making process based on the sushi making equipment one is using. This can be for either individual needs or for industrial production of sushi rice. In one embodiment, the amount of desired rice is between about 0.25 kg and about 10 kg for making an individual batch using the process of the present invention. In a narrower embodiment it is between about 1 kg and about 7 kg.

As used herein, the term “cooked rice kernels” refers to the uncooked rice kernels as described above to which sufficient water has been added that is hot enough to cook the rice to doneness for eating. The amount of water to cook rice is within the skill of the art and varies normally with the type of rice, age of rice, the conditions during the cooking process (temperature and humidity e.g.), and the desired consistency of the rice after cooking (i.e. vary the wetness or mushiness of the rice). These parameters, in general do not alter the ability to thaw the present invention rice by conventional means or other means for that matter (e.g. microwave).

As used herein the term “sushi vinegar” or “seasoned rice vinegar” refers to vinegar utilized to make sushi, normally a white rice vinegar though any suitable sushi vinegar is acceptable. Typically, for every kilogram of cooked sushi rice there is added about ¼ liter to about ⅓ liter sushi vinegar, however, the exact amount is within the skill of the art. The rice vinegar can already have the combination of sugars comprising one or more of sucrose, high fructose corn syrup, and brown sugar. One could also add one or more of sucrose, high fructose corn syrup, and brown sugar to plain sushi vinegar at the last minute. In general, one skilled in the art is capable of adding sufficient sushi vinegar to cooked rice kernels to make sushi rice. The sugars can be added to the rice separately, i.e. directly to the cooked rice. The amount of combination of sugars whether present in the sushi vinegar or added separately is easily determined by one skilled of the art in view of this disclosure. The present invention relies on the addition of Trehalose to the cooked rice kernels with or without the addition to the combination of sugars to achieve the results claimed herein.

As used herein the term “frozen” refers to bringing the rice of the present invention down below the freezing point of water but as low can be taken to 15 to 30 degrees C. below zero as desired for long term freeze storage.

As used herein the term “conventionally thawed” or “thawed by convention means” refers to placing the frozen rice of the present invention in an atmospheric temperature of about 5 to about 30 degrees C. (above freezing temperatures) for about 2 to 10 hours or as otherwise desired or within the skill in the art for slow temperature defrosting. Frequently, this means, in one embodiment, placing the frozen sushi rice of the present invention in the refrigerator portion of a cooling device which does not hold at freezing temps but does hold below ambient temps. Ambient temperature could also in one embodiment be utilized to thaw the frozen rice of the present invention.

Once conventionally thawed, the rice can then be utilized to prepare conventional room temperature sushi. The length of time is within one skilled in the art to defrost frozen items at conventional temperatures without use of a microwave or the like while these methods could be used to defrost the present invention it is not the core of the present invention's utility.

As used herein the term “combination of sugars” refers to from 0% to about 13% of the weight of the uncooked rice of a combination of sugars comprising at least one or more of sucrose, high fructose corn syrup, and brown sugar which is added to cooked sushi rice kernels, to which additional sugar consisting of the form of trehalose (and no other sugars) is added either in the sushi vinegar or directly to the cooked sushi rice. The trehalose used in the present invention is between at least 9% to about 60% by weight of the uncooked rice kernels and combination of sugars combined. In one embodiment the trehalose is at least or greater than about 12%, 15%, 20%, 25%, or 30% by weight of the uncooked rice kernels and combination of sugars together. In another embodiment the trehalose is not more than about 25%, 34%, or 48% by weight of the uncooked rice kernels and combination of sugars combined. In one embodiment, there is between about 0.1 kg and about 0.2 kg trehalose added in for every kilogram of uncooked rice kernels used in the process of the present invention.

As used herein the term “coats at least a portion of an outer surface of the rice kernels” refers to the process of adding the trehalose to the cooked rice kernels in a manner that it coats the rice kernels at least partially (in one embodiment at least 50%), in one embodiment, the trehalose and combination of sugars substantially coats the entire kernel of rice. The trehalose is added to the cooked sushi to accomplish the coating either separate or mixed with the combination of sugars first either in the sushi vinegar or separately. This can be done while adding the vinegar and sugar to the cooked rice during the process of making sushi normally while the sushi rice is cooling the vinegar and sucrose are added so this is a embodiment of when to add the trehalose, e.g. by combining them all or can be done sequentially. Normally, the sugars and vinegar are added during the rice cooling process and one skilled in the art would add the trehalose when the sucrose, high fructose corn syrup, or brown sugar was added in a normal manner. In one embodiment, sushi rice tumblers are used to mix the vinegar and combination of sugars to achieve a coated rice kernel of the present invention. One skilled in the art in view of the present disclosure could find methods of coating the kernels after cooking. It is noted that in the present invention the addition of trehalose to the cooking water of the uncooked rice kernels does not result in the present invention coated particles.

The method of the present invention involves selecting a desired amount of uncooked rice kernels as described above. The rice is then cooked in sufficient heated water to cook the rice to doneness for consumption. Only then after the rice is cooked normally while the rice is in the process of cooling, is the vinegar and combination of sugars added. This can be done sequentially or two or more ingredients all together in combination. The rice is normally cooled to room temperature and formed into a shape as desired for freezing or just frozen as a block or sheet of sushi rice for later conventional thawing.

### EXAMPLE

A combination of 2.5 kg of Cal Rose medium grain rice was combined with 1.0 kg of short grain sweet rice. The combination was machine washed through one cycle of a rice washing device, though hand washing could also be acceptable. The washed rice was placed in a cooking vessel with enough water to cover the rice along with 2 tablespoons of sea salt, thoroughly mixed and allowed to sit for 30 minutes (normally the sitting range can be from about 15 minutes to about an hour).

The rice mixture was placed in an automatic rice cooker and the water level adjusted to in accordance to the age of the rice. The rice was cooked for a time of about 20 minutes and allowed to rest for about 30 minutes (range of 15 to 60 minutes). One liter of preseasoned sushi vinegar (having 456 grams of sugar, a combination of sucrose, high fructose corn starch, and/or brown sugar) is mixed with 16 ounces of powdered Trehalose in a blender until thoroughly mixed. The mixture is divided in two, and half of the mixture is placed in a rice tumbler and cooling robot to which the cooked rice is added. The remaining mixture is poured over the cooked rice and the cycle of the tumbler set for 560 seconds and run through two cycles. The rice is removed from the tumbler and allowed to rest at an ambient temperature for about 20 minutes before use or freezing.

The following chart exemplifies products of the present invention with no sugars or combinations of sugar and trehalose:

| | | | | oz | oz | | Total | oz | | Total |
|---|---|---|---|---|---|---|---|---|---|---|
| | kilos | lbs | oz | sugars* | Trehalose | Trehalose % | Sugars | Trehalose | Trehalose % | Sugars |
| Seasoned | | | | | | | | | | |
| Rice | | | | | | | | | | |
| Vinegar | | | | | | | | | | |
| uncooked | 3.5 | 7.7 | 123.2 | 16 | 12 | 9.74% | 22.73% | 24 | 19.48% | 32.47% |
| rice | | | | | | | | | | |
| cooked | | 18 | 288 | 16 | 12 | 4.17% | 9.72% | 24 | 8.33% | 13.89% |
| rice | | | | | | | | | | |
| uncooked | 3.5 | | 123.2 | 10 | 25.2 | 20.45% | 28.57% | 37.2 | 30.19% | 38.31% |
| rice | | | | | | | | | | |
| reduction | | | | | | | | | | |
| of sucrose | | | | | | | | | | |
| cooked | | 18 | 288 | 10 | 25.2 | 8.75% | 12.22% | 37.2 | 12.92% | 16.39% |
| rice | | | | | | | | | | |
| reduction | | | | | | | | | | |
| of sucrose | | | | | | | | | | |
| Rice | | | | | | | | | | |
| Vinegar | | | | | | | | | | |
| No Sugars | | | | | | | | | | |
| uncooked | 3.5 | | 123.2 | 0 | 47.2 | 38.31% | 38.31% | 59.2 | 48.05% | 48.05% |
| rice total | | | | | | | | | | |
| Trehalose | | | | | | | | | | |
| cooked | | | 288 | 0 | 47.2 | 16.39% | 16.39% | 59.2 | 20.56% | 20.56% |
| rice total | | | | | | | | | | |
| Trehalose | | | | | | | | | | |

reduction formula
*sucrose (brown sugar, cane sugars) 2.2 times for Trehalose
*high fructose corn syrup 2.6 times for Trehalose

Those skilled in the art to which the present invention pertains may make modifications resulting in other embodiments employing principles of the present invention without departing from its spirit or characteristics, particularly upon considering the foregoing teachings. Accordingly, the described embodiments are to be considered in all respects only as illustrative, and not restrictive, and the scope of the present invention is, therefore, indicated by the appended claims rather than by the foregoing description or drawings. Consequently, while the present invention has been described with reference to particular embodiments, modifications of structure, sequence, materials and the like apparent to those skilled in the art still fall within the scope of the invention as claimed by the applicant.

What is claimed is:

1. A sushi rice which is capable of being frozen and then conventionally thawed comprising uncooked sushi rice kernels which have been cooked to produce cooked rice kernels to which has been added:
a) sushi vinegar;
b) a combination of sugars consisting of one or more of sucrose, high fructose corn syrup, and brown sugar of from 0% to about 13% by weight of the uncooked sushi rice kernels;
c) trehalose of from not less than 9% and not more than about 60% by weight, of the combination of sugars and uncooked sushi rice kernels combined; and
d) wherein the combination of sugars and trehalose has been mixed with the cooked rice kernels such that they coat at least a portion of an outer surface of the cooked rice kernels.

2. The sushi rice according to claim 1 wherein the trehalose is between greater than 12% and about 20% by weight of the cooked rice kernels and combination of sugars together.

3. The sushi rice according to claim 1 which has been frozen.

4. The sushi rice according to claim 3 which has been thawed by conventional means.

5. The sushi rice according to claim 1 where in the cooked rice kernels are a combination of short and medium grain rice kernels.

6. The sushi rice according to claim 5 wherein the ratio of short to medium grain rice is from about 1:3 to about 3:1 by weight.

7. The sushi rice according to claim 6 wherein the ratio of short to medium grain rice is about 1:2.5.

8. A method of making sushi rice which is capable of being frozen and then conventionally thawed comprising;
a) selecting a desired amount of uncooked rice kernels;
b) cooking the uncooked rice kernels in sufficient heated water to form cooked rice kernels;
c) adding to the cooked rice kernels a combination of sugars comprising of at least one of sucrose, high fructose corn syrup, and brown sugar such that sugars are from about 0% to about 13% by weight of the uncooked rice;
d) adding to the cooked rice kernels trehalose together with the combination of sugars or separately of not less than 9% nor more than about 60%, by weight, of the uncooked sushi rice kernels and combination of sugars combined; and
e) making the addition of c) and d) in a manner wherein at least a portion of the cooked rice kernels are coated with the combination of sugars and trehalose.

9. The method of making sushi rice according to claim 8 which comprises the additional step of freezing the rice.

10. The method of making sushi rice according to claim 9 which comprises the additional step of defrosting the rice by conventional means.

11. The method of making sushi rice according to claim 8 wherein the trehalose is between greater than 12% and about 20% by weight of the uncooked sushi rice and sugars together.

12. The method of making sushi according to claim 8 wherein there is between about 0.1 kg to about 0.45 kg trehalose added for every kilogram of uncooked rice kernels used.

13. The method of making sushi according to claim 8 wherein the combination of sugars is added to the cooked rice kernels while the rice is cooling.

14. The method of making sushi according to claim 8 wherein the desired quantity of uncooked rice kernels is between about 0.25 kg and about 10 kg.

15. The method of making sushi according to claim 14 wherein the desired quantity of uncooked rice kernels is between about 1 kg and about 7 kg.
